(19) United States
(12) Patent Application Publication
(10) Pub. No.: US 2009/0186730 A1
(43) Pub. Date: Jul. 23, 2009

(54) SILENT CHAIN

(75) Inventor: Takashi Tohara, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/333,641

(22) Filed: Dec. 12, 2008

(30) Foreign Application Priority Data
Jan. 17, 2008 (JP) 2008-007859

(51) Int. Cl. F16G 13/04

(52) U.S. Cl. 474/213

(57) ABSTRACT

In a silent chain, the outer diameter of each connecting pin gradually increases from its ends toward a central region at an intermediate location between its ends, whereby the diameter of each pin is greatest in its central region. The pin holes of the inner plates can have the same inner diameter, which can be slightly larger than the largest outer diameter of the connecting pins. The gradual increase in the outer diameter of each pin is sufficiently small that, when a tensile load is applied to the chain, a connecting pin can be flexed by abutting inner surfaces of the pin holes of the chain's non-guide row plates, by an amount sufficient to make the abutment region of the pin substantially straight and in substantially uniform contact with the abutting inner surfaces of the pin holes.

### CROSS-REFERENCE TO RELATED APPLICATION

This application claims priority on the basis of Japanese patent application 2008-007859, filed Jan. 17, 2008. The disclosure of Japanese application 2008-007859 is hereby incorporated by reference.

### FIELD OF THE INVENTION

The invention relates to a silent chain for use in a power transmission mechanism such as the timing chain of an automobile engine, or a transmission chain used in industrial machinery, transfer machinery, and the like.

### BACKGROUND OF THE INVENTION

A conventional silent chain, such as the chain described in U.S. Pat. No. 6,485,385, is an endless chain comprising guide rows and non-guide rows of plates. Each guide row is composed of a pair of opposed guide plates and a plurality of inner guide row plates disposed between the pair of guide plates. Each guide row plate has a pair of teeth for engagement with sprocket teeth, and a pair of pin holes. Each non-guide row is composed of a plurality of non-guide row plates. Each non-guide row plate also has a pair of teeth for engagement with sprocket teeth, and a pair of pin holes. The guide rows and non-guide rows are arranged alternately along the length of the chain, and the plates of the each non-guide row are interleaved with the plates of two adjacent guide rows and extend between the guide plates of those adjacent guide rows. Connecting pins connect the guide rows and non-guide rows in articulating relationship. Each connecting pin is fixed to a pair of guide plates at opposite ends of a guide row and fits loosely through holes in interleaved non-guide row plates and guide row plates.

FIG. 6 shows an example of a conventional silent chain under a low tensile load. The silent chain 11 has guide row plates 13 and 13a, interleaved with non-guide row plates 14 and 14a. Each such plate has a pair of teeth (not shown) and a pair of pin holes 12. The plates 13 and 13a are arranged in guide rows 15 and the plates 14 and 14a are arranged in non-guide rows 16.

Toothless guide plates 17 are provided at both ends of each guide row 15 on the outermost sides of the chain. The opposite guide plates 17 connected to each other by connecting pins 19. The connecting pins 19 fit loosely in pin holes 12 of the plates 13, 13a, 14, and 14a. End portions of the connecting pin 19 fit tightly into pin holes 18 of the guide plates 17 so that the connecting pins are firmly secured to the guide plates. Each connecting pin 19 is a cylindrical pin having a uniform circular cross-section.

If the total number of toothed plates, 13 and 13a, in each guide row 16 is n (for example four), the total number of toothed plates 14 and 14a in each non-guide row is n+1 (for example five). Each guide row also has a pair of toothless guide plates 17, so that the total number of plates in each guide row is n+2 (for example, six). Since the number of the plates in each guide row 15 is larger than the number of the plates in each non-guide row 16, the guide row plates 13, 13a and 17 are made thinner than the non-guide row plates 14 and 14a in order to balance the strengths of the guide rows 15 and the non-guide rows 16.

When a high tensile load, such as normally encountered in power transmission, is applied to the chain, the connecting pins 18 bend slightly, as shown in FIG. 7. The bent connecting pins 19 come into contact with pin holes 12 of the inner guide row plates 13a, i.e., the guide row plates near the center of the chain. The bent connecting pins also come into contact with pin holes 12 of the outermost non-guide row plates 14a. As a result, high stress is applied to the centrally located guide row plates 13a while relatively low stress is applied to the outermost guide row plates 13. On the other hand, in the non-guide rows 16, stress is concentrated in the outermost non-guide row plates 14a, while relatively low stress is applied to the centrally located non-guide row plates 14. Since the loads applied to the various plates are different, good stress balance is not achieved.

Furthermore, since very high stress is applied to the outermost non-guide row plates 14a, excessive surface pressure is applied at the abutment between the pins 19 and the inner circumferential surfaces of the pin holes 12 in plates 14a. As a result, when the chain is flexed as it moves around a sprocket, wear occurs both in the connecting pins and the pin holes, causing chain elongation and leading to the possibility of rupture of the chain.

To address the above-described problems, the thickness of the outermost non-guide row plates 14a can be made greater than that of the other non-guide row plates 14. However, if this approach is taken, the mass of the silent chain itself is increased, the number of different types of toothed plates required for manufacture of the chain is increased.

In addition, when the conventional silent chain 11 is used as a timing chain in an engine, the above-described problems result in adverse environmental effects such as impaired fuel efficiency and generation of excessive noise. If a higher strength silent chain is used, its increased mass further decreases engine fuel efficiency.

In checking failed timing chains, it was found that some of the connecting pins were bent in directions corresponding to the direction of the applied tensile force, and at the same time rupture areas were generated in at least 90% of the outermost non-guide row plates. In measurement of abrasion wear, it was found that the wear of the pin holes of the outermost non-guide row plate 14a was greater than that of the other toothed plates 13, 13a, and 14.

I have determined that, if the connecting pins come into uniform contact with the pin holes of all the plates of at least the non-guide rows i.e., plates 14 and 14a, even where bending of the connecting pins occurs as a result of a high tensile load, the load applied to non-guide row plates can be equalized. In this way, local wear, chain wear elongation, and rupture of the connecting pins and the pin holes of the non-guide row plates can be suppressed.

Accordingly, an object of the invention is to solve the above-described problems, and to provide a silent chain in which even where the connecting pins are flexed as a result of a high tensile load, the connecting pin can be brought into substantially uniform contact with the pin holes of the non-guide rows. As a result, the stress balance of the non-guide row plates can be improved, chain strength reduction can be prevented, wear occurring between the pin holes and the connecting pins can be reduced, and chain wear elongation can be suppressed.

### SUMMARY OF THE INVENTION

The elongated silent chain of the invention comprises guide rows and non-guide rows of plates. Each guide row is composed of a pair of opposed guide plates and a plurality of inner guide row plates disposed between the pair of guide plates. Each guide row plate has a pair of teeth for engagement with sprocket teeth, and a pair of pin holes. Each non-guide row is composed of a plurality of non-guide row plates. Each non-guide row plate also has a pair of teeth for engagement with sprocket teeth, and a pair of pin holes. The guide rows and non-guide rows are arranged alternately along the length of the chain, and the plates of the each non-guide row are interleaved with the plates of two adjacent guide rows and extend between the guide plates of those adjacent guide rows. Connecting pins connect the guide rows and non-guide rows in articulating relationship. Each connecting pin has a circular cross-section, and is fixed to a pair of guide plates at opposite ends of a guide row. Each connecting pin fits loosely through holes in interleaved non-guide row plates and guide row plates. The outer diameter of each connecting pin gradually increases from its ends toward a central region at an intermediate location between its ends, so that the diameter of each pin is greatest in its central region.

Because of the gradual increased in the diameter of each connecting pin from its ends toward an intermediate location between its ends, the surface pressures acting on the contact areas between the inner circumferential surfaces of the pin holes and the connecting pin extending therethrough become substantially equalized, and wear of the both elements is suppressed. Consequently, chain wear elongation, and rupture of individual plates can be prevented, and, at the same time, the generation of noise due to wear elongation can be suppressed.

Preferably, all the pin holes of each non-guide row plate and all the pin holes of inner guide row plates have the same inner diameter, which is larger than the largest outer diameter of the connecting pins. Consequently, the plates of the guide rows can be made according to a unified standard, and the plates of the non-guide row can also be made according to a unified standard, so that manufacture of the chain can be simplified.

Preferably, the gradual increase in the outer diameter of each connecting pin is sufficiently small that, when a tensile load is applied to the chain, each connecting pin in a part of the chain under tensile load can be flexed by forces applied to abutment regions of the pins in that part of the chain by abutting inner surfaces of the pin holes of the non-guide row plates through which the pins in that part of the chain extend. The pin can flex by an amount sufficient to make the abutment regions substantially straight, so that each substantially straight abutment region is uniformly in contact with all of the abutting inner surfaces of pin holes of the non-guide row plates through which it extends. Thus, when a high tensile load is applied to the chain, the loads applied to the plates of the non-guide row are equalized and the stress balance of the plates is improved.

### BRIEF DESCRIPTION OF THE DRAWINGS

FIG. 1 is a plan view showing a part of a silent chain according to the invention;

FIG. 2 is partially broken away side elevational view of the silent chain;

FIG. 3(a) is a side elevational view of an inner plate of the chain;

FIG. 3(b) is a side elevational view of a guide plate of the chain;

FIG. 4 is a sectional view showing a portion of the silent chain of the invention in a case in which a low tensile load is applied to the chain;

FIG. 5 is a sectional view similar to FIG. 4, but showing the same portion of the silent chain in a case in which a high tensile load is applied;

FIG. 6 is a sectional view of a conventional silent chain subjected to a low tensile load; and

FIG. 7 is a sectional view of the conventional silent chain subjected to a high tensile load.

### DETAILED DESCRIPTION OF THE PREFERRED EMBODIMENTS

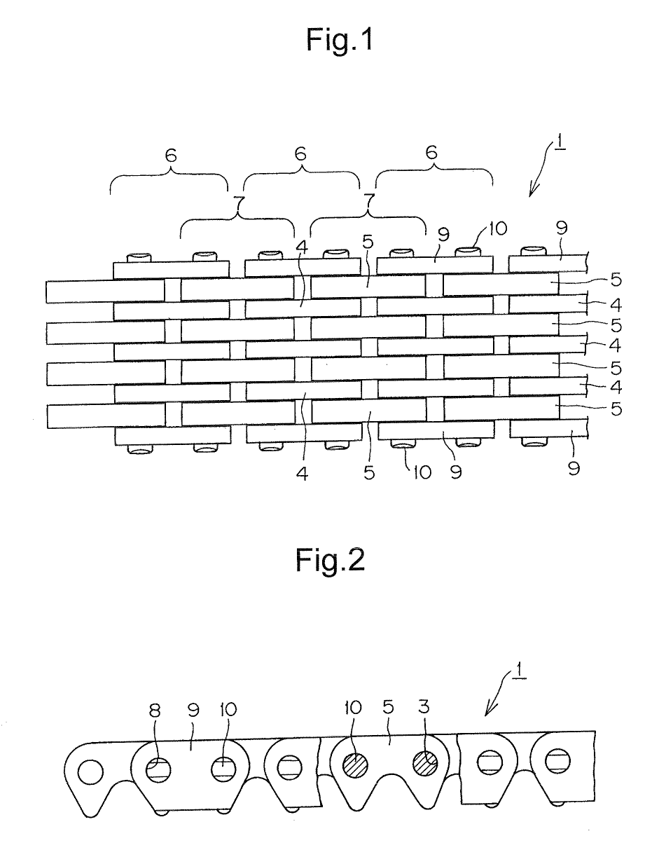

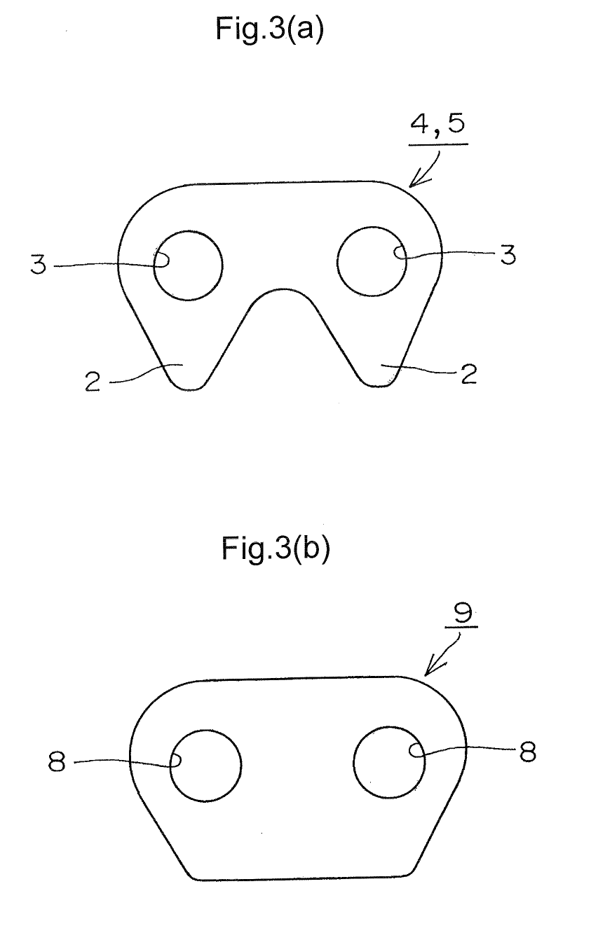

As shown in FIGS. 1 to 3(b), silent chain 1 is composed of interleaved rows of inner plates 4 and 5, each inner plate having a pair of teeth 2 and a pair of pin holes 3. The chain is formed into an endless loop for meshing engagement with sprockets (not shown) in a power transmission mechanism such as the timing drive of an internal combustion engine. The plates 4 and 5 are respectively disposed in guide rows 6 and non-guide rows 7 alternating with one another along the longitudinal direction of the chain. Guide plates 9, each having a pair of pin holes 8, but no teeth, are arranged on the opposite ends of each guide row 6 so that guide plates are disposed along both sides of the chain. Connecting pins 10, which have a circular cross-section, fit loosely in the pin holes 3 of the inner plates 4 and 5, and the ends of the connecting pins 10 fit tightly in the pin hole 8 of the guide plate 9. Therefore, the inner plates 4 and 5 can rotate about the pins, but the guide plates are fixed to the pins.

In the silent chain 1 the number of plates in each guide row exceeds the number of plates in each non-guide row, as in the case of the conventional silent chain 11. To balance the strengths of the guide rows 6 and the non-guide rows 7, the inner plates 4 and the guide plates 9 of the guide rows are thinner than the plates 5 in the non-guide rows. Although the illustrated embodiment has five plates in each of its guide rows and four plates in each of its non-guide rows, the chain can have different numbers of plates. In most cases, the number of plates in each guide row will exceed by one plate the number of plates in each non-guide row.

The inner plates 4 and the inner plates 5 have the same profile, as shown in FIG. 2(a). The inner diameters of the pin holes 3 are all the same size, and slightly larger than the largest outer diameter of a connecting pin 10.

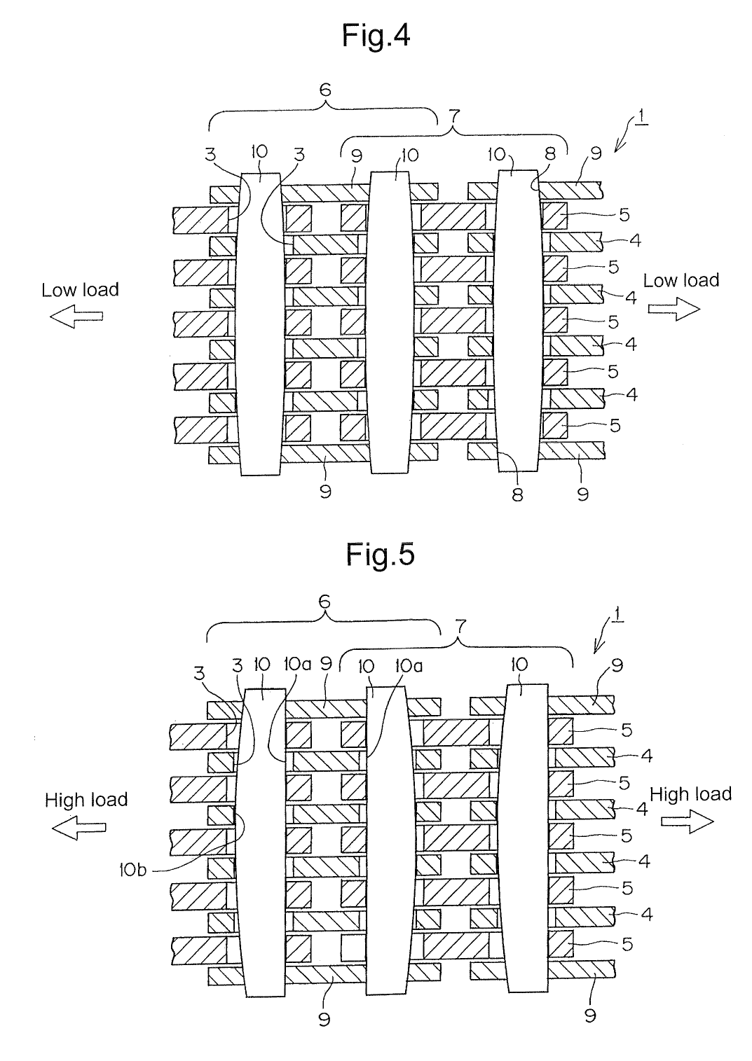

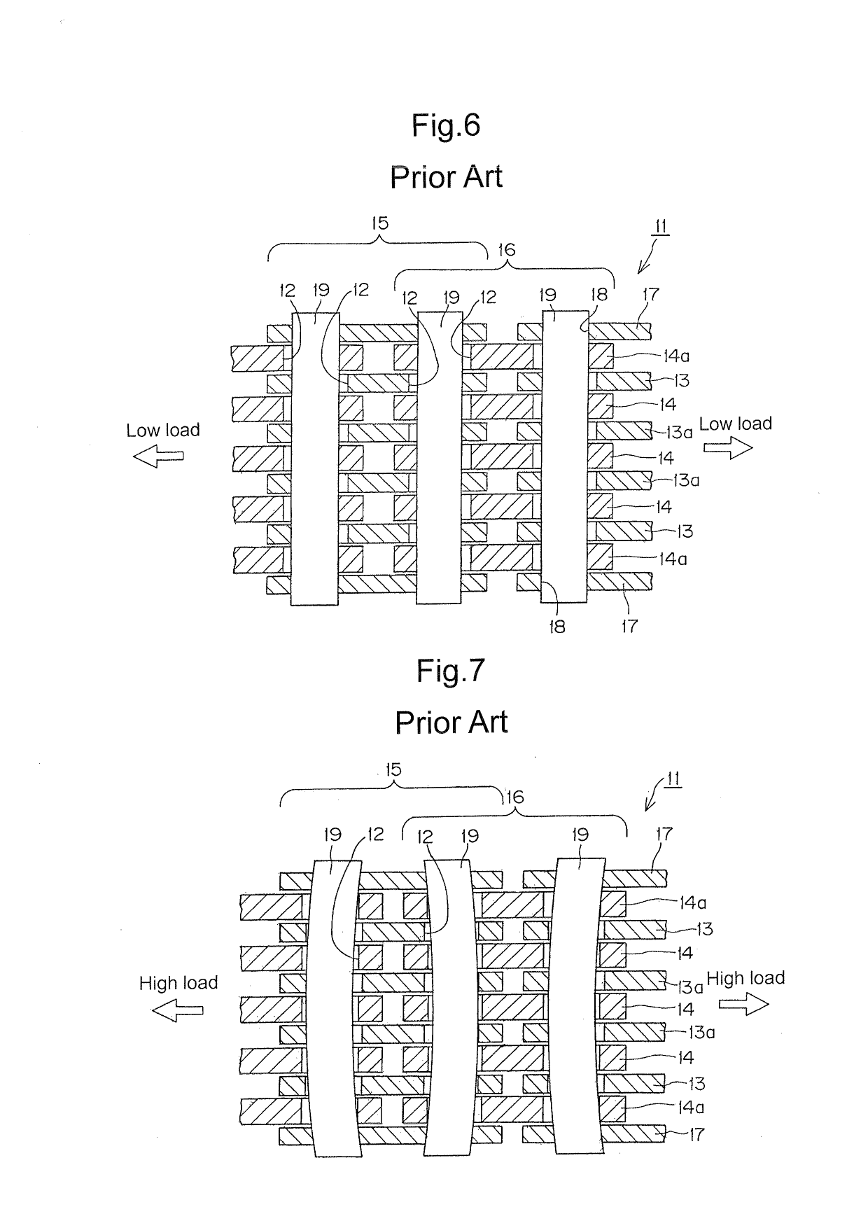

The pins have circular cross-sections, and the manner in which both ends of each connecting pin 10 are press-fit in pin holes 8 of the guide plates 9 is shown in FIG. 4. As seen in FIG. 4, the outer diameter of each connecting pin 10 gradually increases from its ends toward its central region, so that the pin diameter is greatest at its central region, approximately midway between its ends. The surfaces of the connecting pins 10 are in the form of centrally bulged, convex, surfaces of revolution, generated by rotation of a smooth, gradual curve about a central axis. Although FIGS. 4 and 5 exaggerate the shapes of the connecting pins for the purpose of illustration, the actual difference between the diameters of the ends of the pins the maximum outer diameter of the central portion is small.

As shown in FIG. 5, when a high tensile load is applied to the chain, regions 10a of the pins are brought into abutment with the inner surfaces of the pin holes of the non-guide row plates 5. Each region 10a is a region disposed along a line on the outer surface of a pin at which contact pressure is concentrated, the line being situated in a plane defined by the central axes of the pins when the chain is stretched in a straight line. The extent of the gradual increase in the outer diameter of the connecting pin 10 is preferably such that, when the maximum tensile load encountered by the chain in normal use is applied to the chain, the connecting pins are flexed by an amount sufficient to make the regions 10a substantially straight.

As the regions 10a become substantially straight due to the application of a high tensile load to the chain, the surface pressures exerted on each pin 10 by the inner circumferential surfaces of the pin holes 3 of a plates of a non-guide row 7 become equalized. Equalization of these surface pressures suppresses wear at the locations of contact between the pin holes 3 and the connecting pins 10, reduces chain wear elongation, and reduces the likelihood of rupture of an inner plate 5. At the same time, the generation of noise due to chain wear elongation is suppressed.

Furthermore, since the abutment regions 10a of the connecting pins 10 becomes substantially straight, and contact pressure between the pins and the inner surfaces of the pin holes 3 of the non-guide row plates tends to become equalized, the stress balance of the inner plates 5 is improved, and reduction of the strength of the chain is prevented. As shown in FIG. 5, a central portion of the curved surface 10b of each connecting pin 10, opposite to the abutment surface 10a, comes into contact with a pin hole 3 of a centrally located inner plate 4 of a guide row 6. However, since both ends of the connecting pin 10 are secured to guide plates 9, the load on the centrally located inner plate 4 is relatively small, and wear of its pin hole 3 is small. Thus, the stress balance of the inner plates 4 is improved, with the result that the stress balance of both the inner plate 4, and the inner plates 5, is improved.

Since the sizes of pin holes 3 and profiles of the inner plates 4 and the inner plates 5 are the same, and only the plate thicknesses differ, the inner plates 4 can be made according to a unified standard, and the inner plates 5 can also be made according to a unified standard. As the result, the manufacture of the silent chain can be simplified.

I claim:

1. An elongated silent chain comprising:
guide rows, each composed of a pair of opposed guide plates and a plurality of inner guide row plates disposed between said pair of guide plates, each of said guide row plates having a pair of teeth for engagement with sprocket teeth, and a pair of pin holes;
non-guide rows, each composed of a plurality of non-guide row plates, each of said non-guide row plates also having a pair of teeth for engagement with sprocket teeth, and a pair of pin holes;
the guide rows and non-guide rows being arranged alternately along the length of the chain, and the plates of the each non-guide row being interleaved with the plates of two adjacent guide rows and extending between the guide plates of said adjacent guide rows; and
connecting pins connecting said guide rows and said non-guide rows in articulating relationship, each said connecting pins having opposite ends, each said connecting pin having a circular cross-section, each said connecting pin being fixed to a pair of guide plates at opposite ends of a guide row, and each said connecting pin fitting loosely through holes in interleaved non-guide row plates and guide row plates; wherein the outer diameter of each said connecting pin gradually increases from its ends toward a central region at an intermediate location between its ends whereby the diameter of each pin is greatest in its central region.

2. A silent chain according to claim 1, in which all the pin holes of each said non-guide row plate and all the pin holes of said inner guide row plates have the same inner diameter, said inner diameter being larger than the largest outer diameter of the connecting pins.

3. A silent chain according to claim 1 in which the gradual increase in the outer diameter of each said connecting pin is sufficiently small that, when a tensile load is applied to the chain, each said connecting pin in a part of the chain under said tensile load can be flexed, by forces applied to abutment regions of said pins in said part of the chain by abutting inner surfaces of the pin holes of the non-guide row plates through which said pins in said part of the chain extend, by an amount sufficient to make said abutment regions substantially straight, whereby each substantially straight abutment region is uniformly in contact with all of the abutting inner surfaces of pin holes of the non-guide row plates through which it extends.

4. A silent chain according to claim 3, in which all the pin holes of each said non-guide row plate and all the pin holes of said inner guide row plates have the same inner diameter, said inner diameter being larger than the largest outer diameter of the connecting pins.
